(19) United States
(12) Patent Application Publication
(10) Pub. No.: US 2026/0151696 A1
(43) Pub. Date: Jun. 4, 2026

(54) GAME CONTROLLER WITH MULTIPLE CONNECTIONS

(71) Applicant: ACCO BRANDS CORPORATION, Lake Zurich, IL (US)

(72) Inventor: Jason A. Biheller, Lake Zurich, IL (US)

(73) Assignee: ACCO BRANDS CORPORATION, Lake Zurich, IL (US)

(21) Appl. No.: 18/963,943

(22) Filed: Nov. 29, 2024

(51) Int. Cl. A63F 13/24

(52) U.S. Cl. CPC A63F 13/24

(57) ABSTRACT

A video game controller includes a body, at least one analog stick, at least two trigger buttons, at least one action button, at least one directional pad operatively installed to the body, a first communication port, and a second communication port disposed in or on the body and operatively connected to one or more processors. The first communication port is configured to receive power from an external power source. The external power source may charge a battery inside the video game controller. The second communication port is configured to output power to an external connectable device. The video game controller may power or charge the external connectable device through the second communication port.

### FIELD OF INVENTION

The present invention relates to game controllers having multiple connections.

### BACKGROUND

As communication standards have evolved, there has been a push towards unifying connectable devices to use the same connector protocols. Companies that once used proprietary connector protocols have been forced to use an industry standard. However, one field that has not completely embraced this transition is the gaming industry. While modern game controllers have made the jump to using the latest connection ports, controllers with multiple connectors still include legacy connectors, such as 3.5 mm ports. These legacy connectors greatly limit the potential utility and innovation that can be made to game controllers.

### SUMMARY OF THE INVENTION

The present disclosure relates to a game controller including multiple connections that allow the video game controller to power devices. As discussed above, there exists a need to replace the instances of multiple connections on gaming controllers including archaic 3.5 mm port with a connector port that offers more utility, such as a USB-C port. In accordance with an embodiment, the controller includes a body. At least one analog stick, at least two trigger buttons, at least one action button, and at least one directional pad is operatively installed to the body. Furthermore, one or more processors disposed in the body are operatively connected to the at least one analog stick, the at least two trigger buttons, the at least one action button, and the at least one directional pad to receive user input via the at least one analog stick, the at least two trigger buttons. First and second communication ports are also operatively connected to the one or more processors. The first communication port may be disposed in or on the body and configured to receive power from an external power source. The second communication port may be disposed in or on the body and configured to output power to an external connectable device.

In one embodiment, the video game controller includes a rechargeable battery. The rechargeable battery transmits power to the external connectable device if the video game controller stops receiving power from the first communication port.

In one embodiment, the second communication port is a universal serial bus (USB) Type-C port.

In one embodiment, the video game controller may be configured to transmit power to a connectable communication port hub. The communication port hub includes multiple communication ports, each configured to receive external connectable devices.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1A illustrates the front of an example game controller.

FIG. 1B illustrates the back of an example game controller.

FIG. 2 illustrates an example game controller with a connectable communication port hub.

FIG. 3 illustrates a block diagram of an example game controller

FIG. 4 illustrates a flow diagram for an example method of passing through power from a game controller to a device connected to the video game controller.

### DETAILED DESCRIPTION

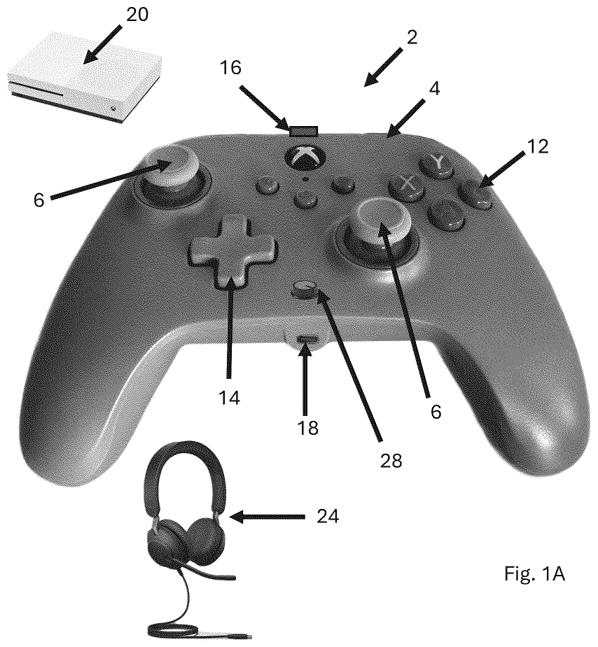

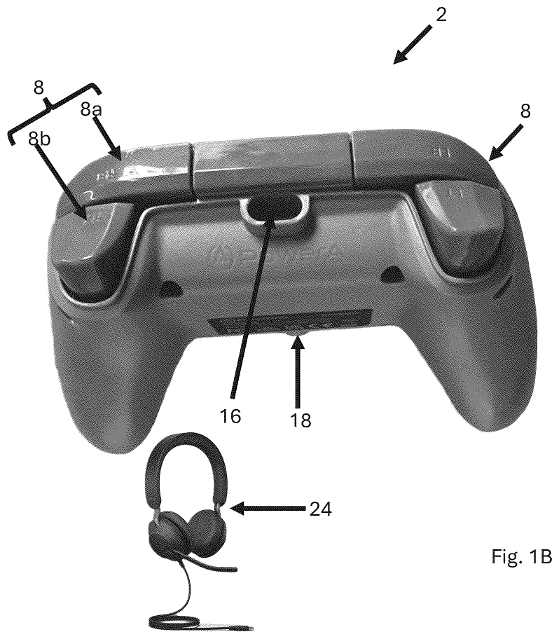

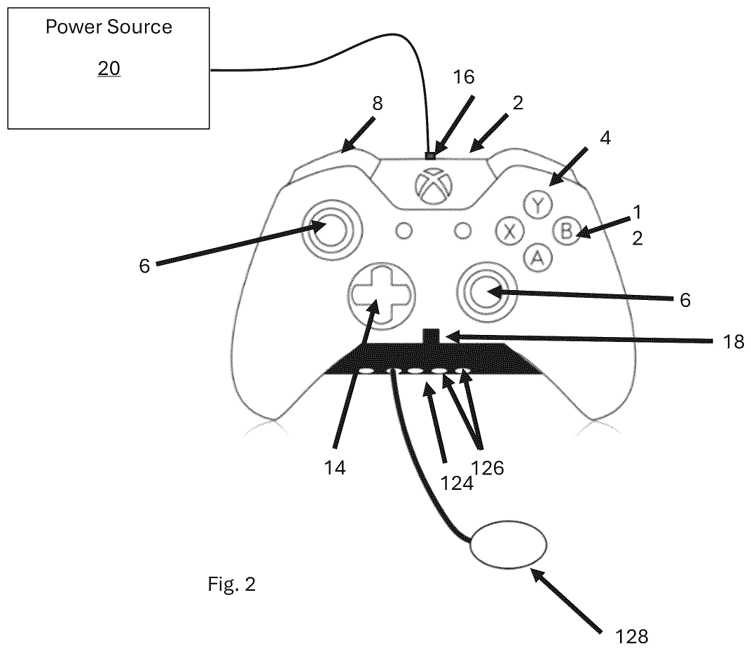

FIG. 1A and FIG. 1B illustrate the front side and the back side of an example game controller 2. The video game controller 2 includes a body 4. Operatively installed to the body 4 may be at least one analog stick 6, at least two trigger buttons 8 (which may include shoulder trigger inputs 8a and lower trigger inputs 8b), at least one action button 12, and at least one directional pad 14 that may serve as a first control interface between the controller's user and a desired video game. In the embodiments depicted in the example game controller 2 in FIGS. 1-2, the control interface of the video game controller 2 includes two analog sticks 6, two trigger buttons 8, multiple action buttons 12, and one directional pad 14.

A first communication port 16 may be connectable to a power source 20. The power source 20 may be, but is not limited to, a game console or a power supply. The power supply may be any hardware including a USB-C port capable of outputting power, such that the video game controller 2 may be charged while connected.

A second communication port 18 may be a USB-C port. The second communication port 18 may be connectable to an external device 24. The external device 24 may include a corresponding USB-C plug. By connecting the second communication port 18 to the external device 24, the video game controller is capable of powering the external device 24. For example, a user is able to connect and use a wired USB-C headset by connecting it to the second communication port 18. If a user owns a wireless headset instead, they have the ability, by plugging the wireless headset to the port 18, to actively charge their headset while still using it, allowing it to function similarly to a wired headset. Another example of a potential use case for the port 18 may be charging a mobile phone. A user may keep their phone nearby and know that it will not be at risk of running low on battery because the port 18 of the video game controller 2 is available for charging the phone.

In some embodiments, the video game controller 2 includes a volume wheel 28. The volume wheel 28 may be used to adjust the volume of a connected wired headset 24. By turning the dial of the volume wheel 28, a user may be able to adjust the volume higher or lower as desired.

FIG. 2 illustrates the front side of a second embodiment of the video game controller 2. The first communication port 16 may be connectable to a power source 20. The power source 20 may be, but is not limited to, a game console or a power supply. The power supply may be any hardware including a USB-C port capable of outputting power, such that the video game controller 2 may be charged while connected.

The second communication port 18 may be configured as a communication port hub 124 or to a communication port hub 124. The communication port hub 124 may include multiple communication ports 126. Each communication port 126 may be configured to receive an external connectable device 128. The communication ports 126 may be USB-C or 3.5 mm ports. In this embodiment, the external connectable devices 128 may be, similar to the first embodiment, a wired headset or phone. However, because the hub 124 has multiple communication ports 126, the advantages are multiplied and enhanced. For example, a possible external connectable device 128 may be a controller-input-generating device such as, for example, a device with additional controller inputs (e.g., action buttons). If a user activates the controller-input-generating device (e.g., by pressing the action buttons), the controller-input-generating device 128 may mirror the input of one of the action buttons 12 or shoulder buttons 8.

By fully utilizing the multiple communication ports 126, a user may connect multiple controller-input-generating devices, allowing the user to operate the video game controller 2 in a manner that better fits their desires, e.g., better ergonomics or accessibility. As the second communication port 18 can pass through power, the external connectable devices 128 are not limited to simple controller-input-generating devices with one input. Even devices that need powered may be used. An entire functional fighting stick or similar usage specific game controller may be plugged into the communication port hub, for example, allowing users an easier time to transition from games that may require just a controller and games that may require more specialized controllers.

The communication port hub 124 may be a permanent part of the video game controller 2 or the communication port hub 124 may be installable (e.g., snap on) to the video game controller 2. In the permanent embodiment, the communication port hub 124 corresponds to the second communication port 18, no discrete second communication port 18 may be necessary. In the installable embodiment, the communication port hub 124 may be removably installed to the video game controller 2 and the second communication port 18 may serve as means for electrically connecting the communication port hub 124 to the video game controller 2.

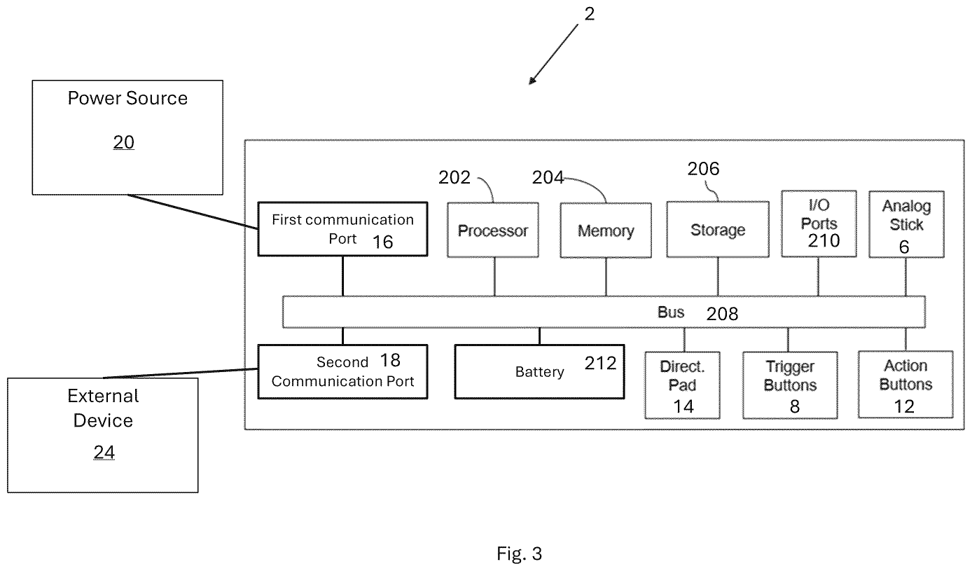

FIG. 3 illustrates a block diagram of the example video game controller 2. The controller may include a processor 202, a memory 204, a first communication port 16, a second communication port 18, and a storage 206 operably connected by a bus 208.

The video game controller 2 may communicate with a gaming device via I/O Ports 210 or via the communication port 16. The handheld video game controller 2 may receive user input via the analog stick 6, the trigger buttons 8, the action buttons 12, the directional pad 14, etc. and transmit user input signals to the gaming device via the I/O Ports 210 or communication port 16. The processor 202 may communicate with the power source 20 (e.g., console) via the first communication port 16. The port 16 may also serve as a power port allowing the power source 20 to power the video game controller 2 and/or charge an internal battery 212. The processor 202 may communicate with the external device 24 via the second communication port 18. The port 18 may also serve to transmit power to the external device 24, allowing the external device 24 to be powered.

In some embodiments, the battery 212 may be large enough to hold tens of thousands of milli-amp hours (mAh) of charge. Therefore, the video game controller 2 may function as a battery bank. In this embodiment, a user may unplug the controller 2 from the power source 20 and the controller 2 will function multiple times longer than a common controller because of the battery's 212 enhanced storage. Depending on the video game controller 2, the standard mAh capacity may range from about 1000 to about 2500 mAh. This may give a user anywhere from 10 to 40 hours of playtime. However, as a hypothetical example, if the battery 212 of the current embodiment included at least 10,000 mAh of charge, a user may see controller playability increase from 40 hours to 160 hours, very significant. In addition to longer playing time, the controller 2 may also be used to charge devices such as, for example, a phone on the go. If a user is traveling, for example, they would be able to use the controller 2 to charge their phone or other devices, without needing to find a power outlet. This may be advantageous in situations such as gaming tournaments, where contestants bring their own controllers 2 and are stuck in the venue for the entire day with no other reliable way to charge their phones. This embodiment, therefore, provides a combination video game controller/portable charger/power bank with 10,000 to 100,000 mAh capacity.

The processor 202 can be a variety of various processors including dual microprocessor and other multi-processor architectures. The memory 204 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM). The storage 206 may be operably connected to the processor 202 via the bus 208. The storage 206 can include, but is not limited to, devices like a magnetic disk drive, a solid-state disk drive, a flash memory card, or a memory stick. The memory 204 can store processes or data. The storage 206 or memory 204 can store an operating system that controls and allocates resources of the video game controller 2.

The bus 208 can be a single internal bus interconnect architecture or other bus or mesh architectures. While a single bus is illustrated, it is to be appreciated that game controller 2 may communicate with various devices, logics, and peripherals using other buses that are not illustrated (e.g., PCIE, SATA, Infiniband, 1394, USB, Ethernet). The bus 208 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The video game controller 2 may interact with input/output devices via I/O Ports 210. Input/output devices can include, but are not limited to, a keyboard, a microphone, a pointing and selection device, cameras, video cards, displays, gaming devices, and the like. The I/O Ports 210 can include but are not limited to, serial ports, parallel ports, and USB ports. The video game controller 2 can operate in a network environment and thus may be connected to network devices via the I/O Ports 210. Through the I/O Ports 210, the video game controller 2 may interact with a network. Through the network, the video game controller 2 may be logically connected to remote devices. The networks with which the handheld game controller 2 may interact include, but are not limited to, a local area network (LAN), a wide area network (WAN), and other networks. The I/O Ports 210 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the I/O Ports 210 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

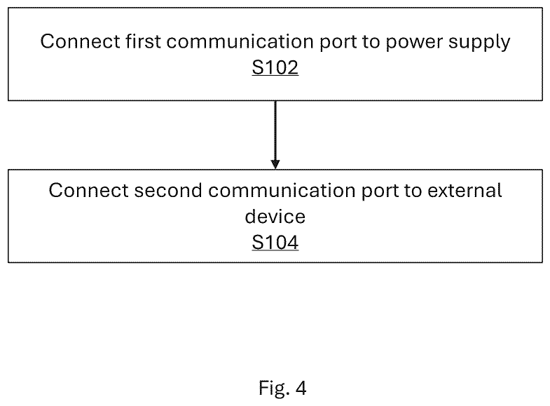

Example methods may be better appreciated with reference to the flow diagram of FIG. 4. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 4 illustrates a flow diagram for an example method 800 for passing power through a game controller 2 into an external device 24. At 810, the method includes connecting a first communication port 16 of the video game controller 2 to a power source 20. At 820, the method includes connecting the second communication port 18 of the video game controller 2 to an external device 24.

Advantages of the video game controller with include, but are not limited to, being able to charge an external device while actively using the video game controller, being able to connect additional controller-input-devices into the video game controller, and being able to charge an external device even when on the go due to the video game controller's large battery.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A video game controller comprising:
a body;
at least one analog stick, at least two trigger buttons, at least one action button, and at least one directional pad operatively installed to the body;
one or more processors disposed in the body operatively connected to the at least one analog stick, the at least two trigger buttons, the at least one action button, and the at least one directional pad to receive user input via the at least one analog stick, the at least two trigger buttons; and
first and second communication ports operatively connected to the one or more processors;
wherein the first communication port is disposed in or on the body and is configured to receive power from an external power source, and
wherein the second communication port is disposed in or on the body and is configured to output power to an external connectable device.

2. The video game controller of claim 1, comprising:
a rechargeable battery operably installed to the body and configured to output power to the external connectable device via the second communication port when the video game controller is not receiving power via the first communication port.

3. The video game controller of claim 1, wherein the second communication port is a universal serial bus (USB) Type-C port.

4. The video game controller of claim 1, wherein the second communication port charges the external connectable device.

5. The video game controller of claim 4, wherein the external connectable device is a wireless headset.

6. The video game controller of claim 4, wherein the external connectable device is a mobile phone.

7. The video game controller of claim 4, wherein the external connectable device is a second game controller.

8. The video game controller of claim 4, further comprising:
a rechargeable battery operably installed to the body and configured to output power to the external connectable device via the second communication port when the video game controller is not receiving power via the first communication port.

9. The video game controller of claim 4, comprising:
a rechargeable battery operably installed to the body and configured to output power to the external connectable device via the second communication port, wherein the power received from the first communication port charges the rechargeable battery.

10. The video game controller of claim 1, wherein the external connectable device is a wired headset.

11. The video game controller of claim 10, further comprising:
a volume wheel disposed in or on the body, operatively connected to the one or more processors, and is configured to adjust the volume of the audio sent to the wired headset.

12. The video game controller of claim 1, wherein the external power source is a game console.

13. The video game controller of claim 1, wherein the power source is a power supply.

14. A video game controller comprising:
a body;
at least one analog stick, at least two trigger buttons, at least one action button, and at least one directional pad operatively installed to the body;
one or more processors disposed in the body operatively connected to the at least one analog stick, the at least two trigger buttons, the at least one action button, and the at least one directional pad to receive user input via the at least one analog stick, the at least two trigger buttons;
a first communication port disposed in or on the body and configured to receive power from an external power source; and
a communication port hub disposed in or on the body and having a plurality of communication ports which are configured to connect to and provide power to a plurality of external connectable devices.

15. The video game controller of claim 14, wherein at least some of the plurality of communication ports are configured to receive input from controller-input-generating devices.

16. The video game controller of claim 15, wherein the controller-input-generating devices include at least one of a trigger button, an action button, or an analog stick.

17. The video game controller of claim 14, wherein the plurality of communication ports include at least one of USB Type-C ports and 3.5 mm jacks.

18. A method of a video game controller powering an external device connected to the video game controller comprising:
connecting a first communication port of the video game controller to a power source; and
connecting a second communication port of the video game controller to the external device such that power supplied from the power source or power supplied from a battery of the video game controller powers the external device.

19. The method of claim 18, wherein the power source is a game console.

20. The method of claim 18, wherein the power source is a power supply.
